(19) United States
(12) Patent Application Publication
(10) Pub. No.: US 2026/0110592 A1
(43) Pub. Date: Apr. 23, 2026

(54) APPARATUS AND METHOD FOR OBTAINING MODE FIELD DIAMETER OF OPTICAL FIBER

(71) Applicant: NTT. Inc., Tokyo (JP)

(72) Inventors: Atsushi NAKAMURA, Musashino-shi, Tokyo (JP); Yusuke KOSHIKIYA, Musashino-shi, Tokyo (JP)

(73) Assignee: NTT. Inc., Tokyo (JP)

(21) Appl. No.: 19/114,288

(22) PCT Filed: Sep. 28, 2022
(86) PCT No.: PCT/JP2022/036132

§ 371 Date: Mar. 21, 2025

(51) Int. Cl. G01M 11/02; G01B 11/12

(52) U.S. Cl. CPC G01M 11/025; G01B 11/12

(57) ABSTRACT

The mode field diameter acquisition device according to the present disclosure is a device for acquiring a mode field diameter of each spatial mode of an optical fiber having a core, through which a plurality of spatial modes can propagate, from a near field pattern, and includes a mode field diameter acquisition unit configured to acquire a mode field diameter of a freely-selected spatial mode using a near field pattern of the spatial mode, and a mathematical expression based on a variational expression of a propagation constant of the spatial mode.

### TECHNICAL FIELD

The present disclosure relates to a device and a method for acquiring a mode field diameter of an optical fiber.

### BACKGROUND ART

With an increase in large-capacity contents, typified by moving images, and games and the spread of smartphones, traffic amount in an optical fiber network is increasing year by year. On the other hand, the limit of the transmission capacity of a single-mode fiber currently used as a transmission medium comes at early date. As one technology for coping with future traffic increase, spatial multiplex transmission using a multi-core fiber or a multimode fiber has attracted attention. In a spatial multiplex transmission system, a plurality of cores and a plurality of spatial modes are used as transmission channels, and it is important to grasp a transmission characteristic of each channel.

The transmission characteristic of the optical fiber is closely related to the electric field distribution of the waveguide mode. The mode field diameter (MFD) is a parameter, from which connection loss deduced, representing the spread of the electric field of a fundamental mode (LP01 mode), and is therefore one of important parameters for grasping the transmission characteristic of a conventional single-mode fiber. Non Patent Literature 1 and Non Patent Literature 2 disclose that connection loss of each spatial mode can be deduced by using, as the MFD, the spot size of the beam waist under a condition where the electric field distribution of the higher mode is approximated by a higher Gaussian mode (Hermitian-Gaussian or Laguerre-Gaussian). Accordingly, the MFD is an important parameter also in an optical fiber having a core, through which a plurality of spatial modes can propagate, such as a multi-mode fiber or a multi-mode multi-core fiber.

For designing a refractive index distribution of an optical fiber, a near field pattern of a desired spatial mode is calculated using electromagnetic field analysis means such as a finite element method, and the MFD is generally calculated from the value. Non Patent Literature 1 and Non Patent Literature 2 disclose, as a method for calculating a higher-mode MFD from a near field pattern, a method using the following definition formula similar to the formula for calculating the MFD of a conventional single-mode fiber.

$$\begin{matrix}[ Math . 1 ] & \\ M F {D}_{v μ} = \frac{2 \sqrt{2}}{\sqrt{v + 2 μ - 1}} {( \frac{{\int }_{0}^{∞} {ψ}_{v μ}^{2} {r}^{3} dr}{{\int }_{0}^{∞} {ψ}_{v μ}^{2} rdr} )}^{1 / 2} & ( 1 )\end{matrix}$$

Here, an MFD represents a mode field diameter, ν and μ represent mode orders in an azimuthal direction and a radial direction of a spatial mode targeted for acquisition, ψ_{νμ} represents an electric field distribution of the LP_{νμ} mode depending on a radial coordinate, and r represents a coordinate in a radial direction.

### CITATION LIST

### Non Patent Literature

Non Patent Literature 1: A. Nakamura et al., “Mathematical model for estimating splice loss in few-mode fibers from mode field diameter,” in Proceedings of the 6th International Symposium on Extremely Advanced Transmission Technologies, P-02, 2021.
Non Patent Literature 2: A. Nakamura et al., “Effective mode field diameter for LP11 mode and its measurement technique,” IEEE Photonics Technology Letters, vol. 28, no. 22, pp. 2553-2556, 2016.
Non Patent Literature 3: A. Nakamura et al., “Mode field diameter definitions for few-mode fibers based on spot size of higher-order Gaussian mode,” IEEE Photonics Journal, vol. 12, no. 2, article number 7200609, 2020.
Non Patent Literature 4: Junichi Sakai, “Hikari douharo no denjikai suchi kaisekihou (in Japanese) (Electromagnetic field numerical analysis method for optical waveguide)”, Morikita Publishing Co., Ltd., 2015.

### SUMMARY OF INVENTION

### Technical Problem

However, the electric field distribution of the spatial mode of the multi-mode fiber or the multi-mode multi-core fiber is actually not identical with that of the strictly higher Gaussian mode; there is a problem of deterioration in accuracy of the connection loss deduced using the MFD obtained by Expression (1) when the difference between the actual electric field distribution and the strictly higher Gaussian mode increases.

That is, the problem is that nobody has clearly known how to acquire the MFD for more correctly deducing the connection loss of an actual multimode fiber or a multi-mode multi-core fiber from the near field pattern.

The present disclosure has been thought out in view of the above circumstances, and an object thereof is to provide a device and a method capable of acquiring an MFD for more correctly deducing the connection loss of each spatial mode of an optical fiber having a core, through which a plurality of spatial modes can propagate, from a near field pattern.

### Solution to Problem

In order to achieve the above object, the mode field diameter acquisition device and the acquisition method according to the present disclosure are designed to acquire the MFD from the near field pattern using a mathematical expression based on a variational expression of a propagation constant derived from a wave equation.

Specifically, a mode field diameter acquisition device according to the present disclosure is a device for acquiring a mode field diameter of each spatial mode of an optical fiber having a core, through which a plurality of spatial modes can propagate, from a near field pattern, and includes a mode field diameter acquisition unit configured to acquire a mode field diameter of a freely-selected spatial mode using a near field pattern of the spatial mode, and a mathematical expression based on a variational expression of a propagation constant of the spatial mode.

A mode field diameter acquisition method according to the present disclosure is a method for acquiring a mode field diameter of each spatial mode of an optical fiber having a core, through which a plurality of spatial modes can propagate, from a near field pattern, and includes a mode field diameter acquisition procedure for acquiring a mode field diameter of a freely-selected spatial mode using a near field pattern of the spatial mode, and a mathematical expression based on a variational expression of a propagation constant of the spatial mode.

The mode field diameter acquisition device according to the present disclosure may further include a near field pattern acquisition unit configured to acquire the near field pattern. Moreover, the mode field diameter acquisition method according to the present disclosure may further include a near field pattern acquisition procedure for acquiring the near field pattern.

In the mode field diameter acquisition procedure, the mode field diameter acquisition unit may calculate a mode field diameter using Expression (4) or Expression (5).

In the mode field diameter acquisition procedure, the mode field diameter acquisition unit may calculate connection loss using Expression (7) or Expression (6).

A program according to the present disclosure is a program for implementation on a computer as each functional unit included in the mode field diameter acquisition device according to the present disclosure, and is a program for directing a computer to execute each procedure included in the mode field diameter acquisition method executed by the mode field diameter acquisition device according to the present disclosure.

Note that the disclosures described above can be combined in any possible manner.

### Advantageous Effects of Invention

The present invention can provide a device and a method capable of acquiring a mode field diameter of each spatial mode of an optical fiber having a core, through which a plurality of spatial modes can propagate, from a near field pattern.

### BRIEF DESCRIPTION OF DRAWINGS

FIG. 1 is a diagram for explaining a configuration example of a mode field diameter acquisition device according to the present embodiment.

FIG. 2 is a flow chart for explaining a mode field diameter acquisition method according to the present embodiment.

FIG. 3 is a diagram for explaining a relationship between a theoretical value and a deduced value of connection loss.

### DESCRIPTION OF EMBODIMENTS

Hereinafter, an embodiment of the present disclosure will be described in detail with reference to the drawings. Note that the present disclosure is not limited to the embodiments described below. These embodiments are merely exemplifications, and the present disclosure can be implemented in forms with various modifications and improvements on the basis of the knowledge of those skilled in the art. Note that components having the same reference signs in the present specification and the drawings denote the same components.

### EMBODIMENTS

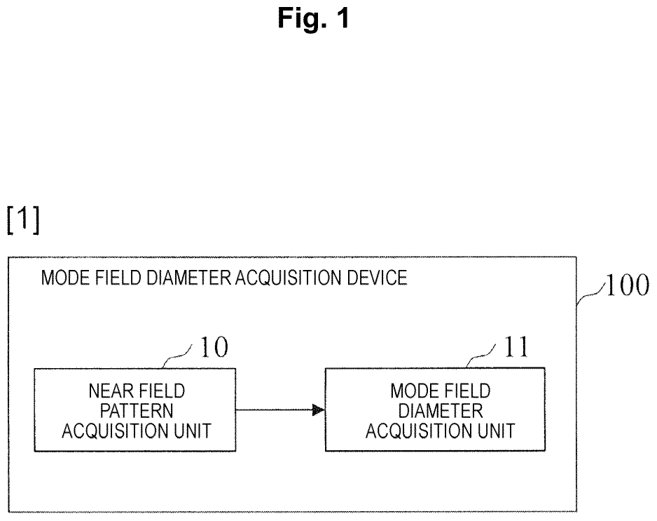

FIG. 1 is a diagram for explaining a configuration example of a mode field diameter acquisition device according to the present embodiment.

A mode field diameter acquisition device 100 according to the present embodiment is a device for acquiring a mode field diameter of each spatial mode of an optical fiber having a core, through which a plurality of spatial modes can propagate, from a near field pattern, and includes: a near field pattern acquisition unit 10 configured to acquire a near field pattern of a freely-selected spatial mode; and a mode field diameter acquisition unit 11 configured to acquire a mode field diameter of the spatial mode using the near field pattern acquired by the near field pattern acquisition unit 10, and a mathematical expression based on a variational expression of a propagation constant of the spatial mode.

The near field pattern acquisition unit 10 is, for example, an electromagnetic field analysis simulator that calculates an electromagnetic field distribution of a freely-selected spatial mode based on a given refractive index distribution, or an electric field distribution measurement device that measures a near field pattern from test light outputted from an optical fiber under test.

The mode field diameter acquisition unit 11 acquires the mode field diameter of the spatial mode using the near field pattern acquired by the near field pattern acquisition unit 10, and the mathematical expression based on the variational expression of the propagation constant of the spatial mode. Details of acquiring the mode field diameter will be described later.

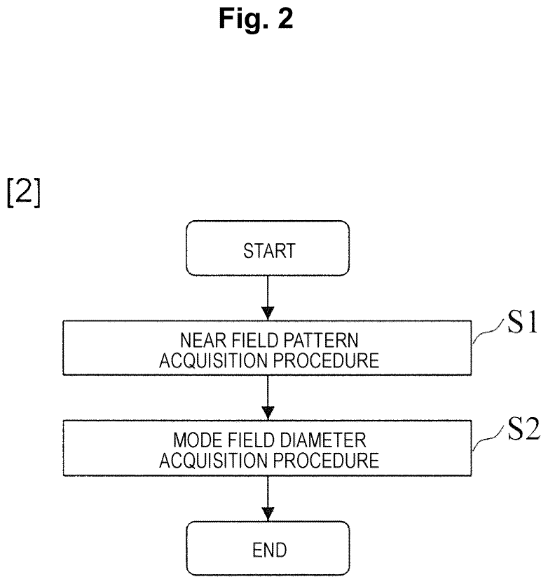

FIG. 2 is a flow chart for explaining a mode field diameter acquisition method according to the present embodiment.

The mode field diameter acquisition method is a method for acquiring a mode field diameter of each spatial mode of an optical fiber having a core, through which a plurality of spatial modes can propagate, from a near field pattern, and includes: a near field pattern acquisition procedure S1 for acquiring a near field pattern of a freely-selected spatial mode; and a mode field diameter acquisition procedure S2 for acquiring a mode field diameter of the spatial mode using the near field pattern acquired in the near field pattern acquisition procedure, and a mathematical expression based on a variational expression of a propagation constant of the spatial mode.

Hereinafter, calculation processing for acquiring the mode field diameter performed by the mode field diameter acquisition unit 11 in the mode field diameter acquisition procedure S2 will be described. The electric field distribution ψ_{νμ} depending on the radial coordinates of the linear polarization mode (LP_{νμ} mode), in which the orders in the azimuthal direction and the radial direction of the core having a cylindrically symmetric structure are ν and μ, satisfies the following wave equation (Non Patent Literature 4).

$$\begin{matrix}[ Math . 2 ] & \\ \frac{1}{r} \frac{d}{dr} [ r \frac{d {ψ}_{v μ} ( r )}{dr} ] + \{ {[ {k}_{0} n ( r ) ]}^{2} - {β}_{v μ}^{2} - \frac{{v}^{2}}{r2} \} ψ ( r ) = 0 & ( 2 )\end{matrix}$$

Here, k₀ represents a wave number in vacuum, n represents a refractive index distribution depending on a radial coordinate, β_{νμ} represents a propagation constant of the LP_{νμ} mode, and r represents a coordinate in a radial direction. From this wave equation, a variational expression regarding the propagation constant β_{νμ} can be expressed by the following expression (Non Patent Literature 4).

$$\begin{matrix}[ Math . 3 ] & \\ {β}_{v μ}^{2} = \frac{{\int }_{0}^{∞} {[ {k}_{0} n ( r ) ]}^{2} {ψ}_{v μ}^{2} rdr - {\int }_{0}^{∞} {( d {ψ}_{v μ} / dr )}^{2} rdr - {v}^{2} {\int }_{0}^{∞} ( 1 / r ) {ψ}_{v μ}^{2} dr}{{\int }_{0}^{∞} {ψ}_{v μ}^{2} rdr} & ( 3 )\end{matrix}$$

From the second and third terms of this expression, the MED of the LP_{νμ} mode is obtained as one of the following Expression (4) and Expression (5).

$$\begin{matrix}[ Math . 4 ] & \\ M F {D}_{v μ} = 2 {\sqrt{2} [ \frac{{\int }_{0}^{∞} {ψ}_{v μ}^{2} rdr}{{\int }_{0}^{∞} {( d {ψ}_{v μ} / dr )}^{2} rdr + {v}^{2} {\int }_{0}^{∞} ( 1 / r ) {ψ}_{v μ}^{2} dr} ]}^{1 / 2} & ( 4 )\end{matrix}$$

$$\begin{matrix}[ Math . 5 ] & \\ M F {D}_{v μ} = 2 \sqrt{2} {\sqrt{v + 2 μ - 1} [ \frac{{\int }_{0}^{∞} {ψ}_{v μ}^{2} rdr}{{\int }_{0}^{∞} {( d {ψ}_{v μ} / dr )}^{2} rdr + {v}^{2} {\int }_{0}^{∞} ( 1 / r ) {ψ}_{v μ}^{2} dr} ]}^{1 / 2} & ( 5 )\end{matrix}$$

Although Expression (4) and Expression (5) differ only in the presence or absence of the coefficient √ (ν+2μ−1), this is due to a difference in definition of the MFD of the multi-mode fiber, and the expressions serve as means of expressing essentially the same MFD.

Note that each MFD of Expression (1) and Expression (5) is a value corresponding to the spot size under a condition where the electric field distribution of the mode targeted for acquisition is approximated by a Laguerre-Gaussian distribution, and in this regard, the connection loss (dB) can be calculated by the following Expression (6).

$$\begin{matrix}[ Math . 6 ] & \\ {α}_{v μ} = \frac{10}{ln ( 10 )} \frac{( v + 2 μ - 1 ) {d}^{2}}{{( M F {D}_{v μ} / 2 )}^{2}} & ( 6 )\end{matrix}$$

Here, d represents an axial deviation amount.

Moreover, when the MFD in Expression (4) is used, the connection loss (dB) can be calculated by the following Expression (7). The connection loss calculated using Expression (4) and Expression (6) is equal to the connection loss calculated using Expression (5) and Expression (6).

$$\begin{matrix}[ Math . 7 ] & \\ {α}_{v μ} = \frac{10}{ln ( 10 )} \frac{{d}^{2}}{{( M F {D}_{v μ} / 2 )}^{2}} & ( 7 )\end{matrix}$$

Note that the mode field diameter acquisition unit 11 can also be realized by a computer and a program, and the program can be recorded on a recording medium or provided through a network.

### EXAMPLES

Numerical calculation was performed in order to confirm that Expression (4) or Expression (5) is more effective than Expression (1) from the viewpoint of deducing the connection loss of the optical fiber having a core, through which the plurality of spatial modes can propagate. The optical fiber (optical fiber under test) used for the numerical calculation was a step-type optical fiber having a core diameter set to 21 μm and a relative refractive index difference set to 0.45%.

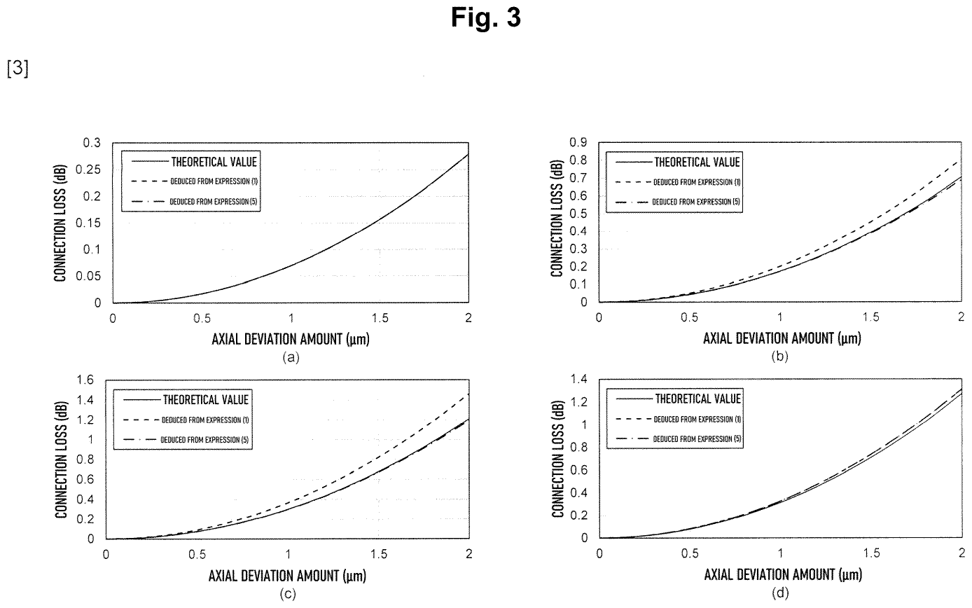

FIG. 3 is a diagram for explaining a relationship between a theoretical value and a deduced value of connection loss. FIGS. 3(a) to 3(d) respectively illustrate results in the LP01 mode, the LP11 mode, the LP21 mode, and the LP02 mode. The horizontal axis represents an axial deviation amount (μm) between optical fibers connected with each other. The vertical axis represents a connection loss (dB) expressed on a logarithmic scale. Each solid line represents a theoretical value of the connection loss. Each broken line denotes a connection loss deduced using the MFD calculated by Expression (1), and Expression (6). Each alternate long and short dash line is a connection loss deduced using the MED calculated by Expression (5), and Expression (6).

With respect to the LP01 mode and the LP02 mode, in which the mode order in the circumferential direction is 0, FIG. 3 shows that the connection losses deduced from the MFDs of Math. 1 and Math. 5 are consistent with the theoretical value. On the other hand, with respect to the LP11 mode and the LP21 mode, in which the mode order in the circumferential direction is not 0, it shows that the connection loss deduced from the MFD of Expression (5) is more consistent with the theoretical value than the connection loss deduced from the MFD of Expression (1). This result shows that the MFD obtained by the present mode field diameter acquisition method is effective for deducing the connection loss of each spatial mode of an optical fiber having a core, through which a plurality of spatial modes can propagate.

### REFERENCE SIGNS LIST

10 Near field pattern acquisition unit
11 Mode field diameter acquisition unit
100 Mode field diameter acquisition device

1. A mode field diameter acquisition device for acquiring a mode field diameter of each spatial mode of an optical fiber having a core, through which a plurality of spatial modes can propagate, from a near field pattern, the mode field diameter acquisition device comprising
a mode field diameter acquisition unit configured to acquire a mode field diameter of a freely-selected spatial mode using a near field pattern of the spatial mode, and a mathematical expression based on a variational expression of a propagation constant for the spatial mode.

2. The mode field diameter acquisition device according to claim 1, wherein the mode field diameter acquisition unit calculates a mode field diameter using Expression C1,
$$\begin{matrix}[ Math . C1 ] & \\ M F {D}_{v μ} = 2 {\sqrt{2} [ \frac{{\int }_{0}^{∞} {ψ}_{v μ}^{2} rdr}{{\int }_{0}^{∞} {( d {ψ}_{v μ} / dr )}^{2} rdr + {v}^{2} {\int }_{0}^{∞} ( 1 / r ) {ψ}_{v μ}^{2} dr} ]}^{1 / 2} & ( C1 )\end{matrix}$$
where MFD represents a mode field diameter, ν and μ represent mode orders in an azimuthal direction and a radial direction of the spatial mode targeted for acquisition, ψ_{νμ} represents an electric field distribution of the LP_{νμ} mode depending on a radial coordinate, and r represents a coordinate in a radial direction.

3. The mode field diameter acquisition device according to claim 1, wherein the mode field diameter acquisition unit calculates a mode field diameter using Expression C2,
$$\begin{matrix}[ Math . C2 ] & \\ M F {D}_{v μ} = 2 \sqrt{2} {\sqrt{v + 2 μ - 1} [ \frac{{\int }_{0}^{∞} {ψ}_{v μ}^{2} rdr}{{\int }_{0}^{∞} {( d {ψ}_{v μ} / dr )}^{2} rdr + {v}^{2} {\int }_{0}^{∞} ( 1 / r ) {ψ}_{v μ}^{2} dr} ]}^{1 / 2} & ( C2 )\end{matrix}$$
where MFD represents a mode field diameter, ν and μ represent mode orders in an azimuthal direction and a radial direction of the spatial mode targeted for acquisition, ψ_{νμ} represents an electric field distribution of the LP_{νμ} mode depending on a radial coordinate, and r represents a coordinate in a radial direction.

4. The mode field diameter acquisition device according to claim 2, wherein the mode field diameter acquisition unit calculates connection loss using Expression C3,
$$\begin{matrix}[ Math . C3 ] & \\ {α}_{v μ} = \frac{10}{ln ( 10 )} \frac{{d}^{2}}{{( M F {D}_{v μ} / 2 )}^{2}} & ( C3 )\end{matrix}$$
where d represents an axial deviation amount.

5. The mode field diameter acquisition device according to claim 3, wherein the mode field diameter acquisition unit calculates connection loss using Expression C4,
$$\begin{matrix}[ Math . C4 ] & \\ {α}_{v μ} = \frac{10}{ln ( 10 )} \frac{( v + 2 μ - 1 ) {d}^{2}}{{( M F {D}_{v μ} / 2 )}^{2}} & ( 4 )\end{matrix}$$
where d represents an axial deviation amount.

6. The mode field diameter acquisition device according to claim 1, further comprising a near field pattern acquisition unit configured to acquire the near field pattern.

7. A mode field diameter acquisition method for acquiring a mode field diameter of each spatial mode of an optical fiber having a core, through which a plurality of spatial modes can propagate, from a near field pattern, the mode field diameter acquisition method comprising
a mode field diameter acquisition procedure for acquiring a mode field diameter of a freely-selected spatial mode using a near field pattern of the spatial mode, and a mathematical expression based on a variational expression of a propagation constant of the spatial mode.

8. A non-transitory storage medium containing a program for implementation on a computer as each functional unit included in the mode field diameter acquisition device according to claim 1.
